(19) United States
(12) Patent Application Publication
(10) Pub. No.: US 2009/0316022 A1
(43) Pub. Date: Dec. 24, 2009

(54) IMAGE RESIZING DEVICE AND IMAGE RESIZING METHOD

(75) Inventor: Toshinobu Hatano, Kyoto (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/484,562

(22) Filed: Jun. 15, 2009

(30) Foreign Application Priority Data
Jun. 23, 2008 (JP) 2008-163592

(51) Int. Cl. H04N 5/262; G06K 9/32

(52) U.S. Cl. 348/240.99; 382/298; 348/E05.055

(57) ABSTRACT

The present invention offers images fully satisfactory to a user with simple processing schemes. An image resizing device, resizing at least a part of an input image, includes: a first boundary setting unit which sets n−1 first boundaries perpendicular to a first direction; a second boundary setting unit which sets m−1 second boundaries perpendicular to a second direction, where n and m are integers not less than 2; and a resizing unit which resizes a first divided area with a first ratio in the first direction, and to resize a second divided area with a second ratio in the second direction, the first and second divided areas being defined by one or two of the first and second boundaries, respectively, and by outer edges of the input image.

### BACKGROUND OF THE INVENTION

(1) Field of the Invention

The present invention relates to retouching for processing and modifying image data. More particularly, the present invention relates to an image resizing device for resizing at least a part of an image, and an image resizing method thereof.

(2) Description of the Related Art

Eliminating the need for film and the development entailing therewith in recent years, digital still cameras have achieved a significant commercial success, and cell-phones including cameras are dominating the market. This has prompted significant advancement and prevalence of techniques in realizing high-speed processing of video signals and image signals obtained by the camera, and high-quality videos and images.

Aside from the advancement in the techniques, most of photographic subjects desire to be “as photogenic as possible” as one of their natural desires. In order to have such a desire realized, disclosed conventional techniques have proposed retouching on obtained image data.

One of the typical retouching techniques involves, first, photographing a person on a digital camera, and sending the image data to a personal computer (PC). Then, taking fully advantage of photo retouching software, retouching is provided to modify a figure or any desired part of the body of the subject. In addition, another disclosed technique has realized to let the camera: resize image data in uniformed ratio in horizontal and vertical directions; and perform retouching on a figure image, utilizing face detection.

Patent Reference 1 (Japanese Unexamined Patent Application Publication No. 11-88906) discloses a technique to have a digital camera adjust a tint of pre-stored image.

FIG. 14 shows a structure of a digital camera described in Patent Reference 1. A digital camera 700 in FIG. 14 itself adjusts a tint of an image before storing-processing. The digital camera 700 has objectives to facilitate the processing of the image and provide a high-quality image.

The digital camera 700 includes an imaging device 701, an inputting device 702, an image processing device 703, a recording device 704, and outputting device 705. The inputting device 702 changes a tint of the image by switching each of: button switches 702Ra, 702Rb, 702Ga, 702Gb, 702Ba, and 702Bb corresponding to the RGB; and a button switch 702c instructing the image processing to be continued. Further, the image processing device 703 includes a memory 711, a data extracting unit 712, a table generating unit 713, and an image format converting unit 714.

Image data, of the photographic subject, taken by the imaging device 701 is stored into the memory 711. The data extracting unit 712 extracts, from the image data stored into the memory 711, particular part of the data used for adjusting colors, and generates a histogram. Based on the histogram generated by the data extracting unit 712, the table generating unit 713 generates color converting table data providing the image an appropriate tint conversion. According to the color converting table data generated by the table generating unit 713, the image format converting unit 714 converts the image data stored into the memory 711 into an image format representing a typical picture size, and provides the converted image data to the recording device 704 and the outputting device 705. The recording device 704 records the image data provided from the image format converting unit 714. The outputting device 705, meanwhile, screen-displays the image data provided from image format converting unit 714.

The user adjusts the RGB color balance by visually checking the screen-displayed image on the outputting unit 705 and operating each of button switches via the inputting unit 702 to correct or adjust the image to provide a more natural or a more desired tint.

As described above, the image processing device 703 included in the digital camera 700 of the Patent Reference 1 is designed to pay attention to a tint for an image data conversion in order to obtain a high-quality image. In other words, the tint adjustment of the image before storing-processing can facilitate image processing and provide a high-quality picture.

Further, Patent Reference 2 (Japanese Unexamined Patent Application Publication 2004-64710) shows an imaging device with a function to correct distortion, of digitalized image data, caused by an imaging lens

FIG. 15A illustrates a structure of a distortion correcting circuit of an imaging device described in Patent Reference 2. The imaging device includes a frame memory 800 and a distortion correcting circuit 810 for distortion correction.

The frame memory 800, including an image processing area 810 and a distortion-corrected area 802, stores an image into each of the areas. The distortion correcting circuit 810 includes a processor unit 811, an input buffer 812, an output buffer 813, and a Direct Memory Access (DMA) transferring unit 814.

The distortion correcting circuit 810 develops digital data for one frame, obtained by an imaging device (not shown), in the frame memory 800, and corrects distortion, caused by the imaging lens, in all of the pixels in this one frame.

FIG. 15B illustrates a pixel processing sequence in the distortion correction. The distortion correcting circuit 810 divides a frame 900 into four quadrants with the point of origin centered, the point of origin being located in the vicinity of the middle of the frame and corresponding to an optical axis. The four quadrants include a first quadrant (Q1) to a fourth quadrant (Q4) with two horizontal axis (X-axis) and vertical axis (Y-axis). The distortion correcting circuit 810 reads out the pixels in each of the divided quadrants with respect to each of lines running parallel to the X-axis from a line closer to the X-axis, and executes distortion correcting on a quadrant basis.

In addition, Patent Reference 3 (Japanese Unexamined Patent Application Publication No. 2008-123086) describes an image processing device resizing at least a part of input image. Specifically, the image processing device described in Patent Reference 3 divides the input image either horizontally or vertically. Then, the image processing device resizes: each of the divided portions of the image in a different ratio in a dividing direction; and in a single ratio in another direction. The image processing device generates a piece of image by compositing the divided and resized portions of the image.

FIG. 16 illustrates image resizing described in Patent Reference 3. FIG. 16 exemplifies an input image divided into two (an image 1 and an image 2) in the vertical direction. In the horizontal direction (in a non-dividing direction), zooming in a single ratio is provided to both of the images 1 and 2. In the vertical direction (in a dividing direction), zooming in a different ratio is provided to each of the first and the second images.

As described above, the image processing device in Patent Reference 3 can divide an image and execute resizing by changing a zoom ratio on the divided image basis, resulting in performing accurate resizing. This allows a user to obtain his or her desired image.

### SUMMARY OF THE INVENTION

The above-described conventional techniques have problems that the simple processing schemes provided by the conventional techniques cannot offer images satisfactory to the user.

Patent Reference 1 merely adjusts a tint of the image, and thus obtains a figure desired by the user requires processing to thoroughly reflect an original image. In addition, the retouching on a PC assumes a high-performance PC with software, which requires a skill and time. As a result more than just the mere tint adjustment is essential to present a desired image to the user. Further, the tint adjustment is not for ordinary people since requiring an advanced technique. Thus, the technique described in Patent Reference 1, forcing the user to execute complex operations, fails to offer an image which the user desires.

Patent Reference 2 has as an objective to provide a low-cost correcting circuit to perform distortion correcting, and make possible most appropriate and efficient image processing in distortion correcting. However, the Patent Reference 2 does not suit a technique for performing partial resizing and generating a single image by utilizing features of a person in the image. Therefore, the technique described in Patent Reference 2 fails to provide an image which the user desires.

Patent Reference 3 enables partial resizing, using simple processing. However, Patent Reference 3 cannot help resizing in a uniform ratio in the non-dividing direction of the image, causing a problem that Patent Reference 3 has limited composition techniques via resizing of a person.

Therefore, the present invention is conceived in view of the above problems and has as an objective to provide an image resizing device generating, utilizing simple processing, an image satisfying a user's natural desire to look “slender, beautiful, to have sparkling eyes, and to have a slender face”, and an image resizing method. In other words, the present invention has as an objective to provide an image resizing device to offer the user a fully satisfactory image with simple processing, and an image resizing method.

In order to solve the above problems, an image resizing device in the present invention, resizing at least a part of an input image, includes: a first boundary setting unit which sets n−1 first boundaries perpendicular to a first direction, the n−1 first boundaries dividing the input image into n pieces in the first direction where n is an integer not less than 2; a second boundary setting unit which sets m−1 second boundaries perpendicular to a second direction, the m−1 second boundaries dividing the input image into m pieces in the second direction which is different from the first direction where m is an integer not less than 2; and a resizing unit which resizes a first divided area with a first ratio in the first direction, and to resize a second divided area with a second ratio, that is different from the first ratio, in the second direction, the first divided area being defined by one or two of the first boundaries and an outer edge of the input image, and the second divided area being defined by one or two of the second boundaries and an outer edge of the input image.

This allows the image to be divided into smaller areas. Varying resizing ratio to resize on the smaller area basis makes possible to execute more flexible resizing processing. Thus, an image to fully satisfy the user can be provided.

The image resizing device may further include a displaying unit which displays an image for display corresponding to the input image, wherein the displaying unit may further display on the image for display an auxiliary line for determining positions of the first and second boundaries, the auxiliary line being movable, and on a basis of the auxiliary line, the first boundary setting unit may set the first boundary, and the second boundary setting unit may set the second boundary.

This allows the image to be displayed in advance, so that the image can be divided as the user desires. Since the image resizing device can execute resizing reflecting the intention of the user more accurately, an image to fully satisfy the user can be provided.

The image resizing device may further include: a face detecting unit which detects a face of a photographic subject in the input image; and a position estimating unit which estimates positions of the face and a body part of the photographic subject, using information on the face detected by the face detecting unit, wherein the first boundary setting unit sets the first boundary, and the second boundary setting unit sets the second boundary, based on the positions of the face and the body part of the photographic subject, the positions being estimated by the position estimating unit.

Detecting a position of the face and estimating positions of a face part including eyes and the nose, or a body part including a waist and the neck based on the position of the detected face, as described above, permits the image resizing device to automatically determine an appropriate dividing position and resizing ratio. In other words, this can provide an image fully satisfactory to the user, dispensing with complex operations the user has to handle.

For example, the position estimating unit may estimate a face part position indicating at least one of positions of an eye, a nose, and a mouth of the photographic subject, and the first boundary setting unit may set the first boundary, and the second boundary setting unit may set the second boundary, based on the face part position estimated by the position estimating unit.

Specifically, the first boundary setting unit may set the first boundary and the second boundary setting unit may set the second boundary, so that the first and second boundaries surround at least one of face part positions, including the face part position, estimated by the position estimating unit.

For example, the position estimating unit may estimate a body part position indicating at least a position of a neck, a shoulder, and a waist of the photographic subject, and the first boundary setting unit may set the first boundary, and the second boundary setting unit may set the second boundary, based on the body part position estimated by the position estimating unit.

Specifically, the first boundary setting unit may set the first boundary, and the second boundary setting unit may set the second boundary, so that the first and second boundaries touch at least one of body part positions, including the body part position, estimated by the position estimating unit.

Further, the face detecting unit may detect the face of the photographic subject in the input image to obtain face information of the face on the center position, a size, a vertical direction, a horizontal direction, and a rotation direction, and the position estimating unit may estimate the positions of the face and the body part of the photographic subject, using the face information obtained by the face detecting unit.

This makes possible a highly-accurate estimation of positions of a face part and a body part. Thus, the dividing position and resizing ratio having higher accuracy can be set as the user desires.

The image resizing device may further include: a face detecting unit which detects a face of a photographic subject in the input image; a position estimating unit which estimates positions of the face and a body part of the photographic subject, using information on the face detected by the face detecting unit; and a displaying unit which displays an image for display corresponding to the input image, wherein the displaying unit may further display on the image for display an auxiliary line for determining positions of the first and second boundaries based on the positions of the face and the body part of the photographic subject estimated by the position estimating unit, the auxiliary line being movable, and on a basis of the auxiliary line, the first boundary setting unit may set the first boundary, and the second boundary setting unit may set the second boundary.

This allows automatic setting and displaying of approximate dividing positions. The user can reset at least one of the first and second boundaries in the case where the user is not satisfied with the approximate dividing positions. Here, the approximate dividing positions enable the user to easily set the dividing reference lines at desired dividing positions. Hence, the image resizing device can provide an image fully satisfactory to the user with more simple operations.

It is noted that the present invention can be implemented as a method to regard the processing units included in the image resizing device as steps, as well as an image resizing device. The present invention may also be implemented as a program causing a computer to execute these steps. Further, the present invention may be implemented as a storing medium such as a computer-readable Compact Disk-Read Only Memory (CD-ROM) storing the program, as well as information, data, and a signal indicating the program. Then, the program, the information, the data and the signal may be distributed via a communications network including the Internet.

Moreover, the present invention may be implemented as a camera including each of the above image resizing devices.

In addition, some or all of the structural elements having each of the above described image resizing devices may be included in a single system Large Scale Integration (LSI). A system LSI, an ultra-multifunction LSI, is manufactured with plural structural units integrated on a single chip. Specifically, the system LSI is a computer system having a micro processor, a ROM, and a Random Access Memory (RAM).

The present invention can generate an image satisfying the user's natural desire to look “slender, beautiful, a décolleté beauty, to have sparkling eyes, to have a slender face, and to have firm upper arms.

### FURTHER INFORMATION ABOUT TECHNICAL BACKGROUND TO THIS APPLICATION

The disclosure of Japanese Patent Application No. 2008-163592 filed on Jun. 23, 2008 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram illustrating a structure of an imaging device including an image resizing unit in a first embodiment;

FIG. 2 is a block diagram illustrating a structure of the image resizing unit in the first embodiment;

FIG. 3 is a block diagram illustrating a structure of a zooming unit in the first embodiment;

FIG. 4 exemplifies each of dividing reference lines and divided areas.

FIG. 5 is a flowchart illustrating operations of the image resizing unit in the first embodiment;

FIG. 6 is a flowchart illustrating details of the image resizing unit in the first embodiment;

FIG. 7A exemplifies an original image and an after-resizing image shown by a displaying device.

FIG. 7B exemplifies an original image and an after-resizing image shown by the displaying device.

FIG. 8 is a flowchart illustrating another image resizing technique in the first embodiment;

FIG. 9 is a block diagram illustrating a structure of an image resizing unit in a second embodiment;

FIG. 10 is a block diagram illustrating a structure of a zooming unit in the second embodiment;

FIG. 11 exemplifies each of dividing reference lines and divided areas.

FIG. 12 shows setting of each of the dividing reference lines by face detecting and resizing.

FIG. 13 is a flowchart illustrating operations of the image resizing unit in the second embodiment;

FIG. 14 is a block diagram illustrating a structure of a conventional digital camera;

FIG. 15A illustrates a structure of a distortion correcting circuit in a conventional imaging device;

FIG. 15B illustrates a processing sequence of pixels in distortion correction; and

FIG. 16 illustrates conventional image resizing.

### DESCRIPTION OF THE PREFERRED EMBODIMENTS

Hereinafter, embodiments of the present invention shall be described in details with reference to the drawings.

### First Embodiment

An image resizing device in a first embodiment can resize an image on a more finely-divided portion basis by setting reference lines for dividing the image in two directions; namely first and second directions.

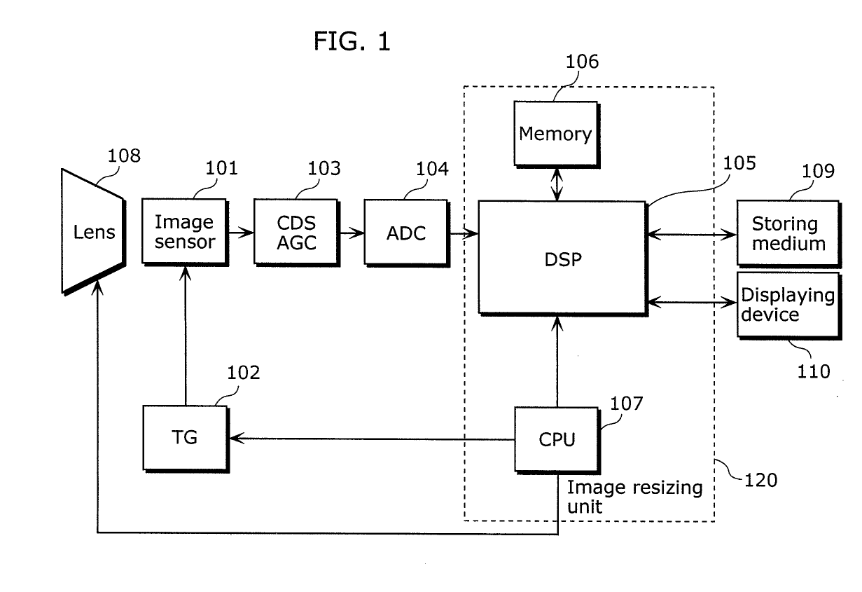

FIG. 1 is a block diagram illustrating a structure of an imaging device 100 including an image resizing unit 120 in the first embodiment. The imaging device 100 in FIG. 1 includes an image sensor 101, a timing generator 102, a correlation double sampling (CDS)/automatic gain control (AGC) circuit 103, an analogue-digital converter 104, a digital signal processing circuit 105, a memory circuit 106, a microcomputer 107, a lens unit 108, a storing medium 109, and a displaying device 110.

The image sensor 101 converts an incident light from a photographic subject via the lens unit 108 to an electric signal, using a photo diode. The image sensor 101 is, for example, a solid state imaging element including a charge coupled device (CCD) and a complementary metal oxide semiconductor (CMOS). Synchronizing with a driving pulse provided from the timing generator 102, the image sensor 101 supplies an analogue image signal to the CDS/AGC circuit 103.

The timing generator 102 (TG: Timing Generator) generates the driving pulse of the image sensor 101. The generated driving pulse is forwarded to the image sensor 101.

The CDS/AGC circuit 103 eliminates noise of the analogue image signal generated by the image sensor 101. Further, the CDS/AGC circuit 103 amplifies the analogue image signal by controlling the gain thereof. Specifically, a sample and hold circuit (the CDS circuit) appropriately reduces 1/f noise of the analogue image signal. Then, the AGC circuit controls the gain of the analogue image signal.

The analogue-digital converter 104 (ADC: Analogue-Digital Converter) converts a signal provided from the CDS/AGC circuit 103 in a digital signal.

The digital signal processing circuit 105 (DSP: Digital Signal Processor) executes various kinds of processing onto the digital signal forwarded from the analogue-digital converter 104, the processing including luminance signal processing, color signal processing, compressing-expanding, and resizing.

The memory circuit 106 stores image data and various kinds of data. The microcomputer 107 executes various kinds of calculating, as well as controls the whole imaging device 100.

It is noted that the image resizing unit 120 includes the digital signal processing circuit 105, the memory circuit 106, and the microcomputer 107. The details of the image resizing unit 120 shall be described hereinafter, using the drawings.

The lens unit 108 condenses the light on the image sensor 101. The storing medium 109 stores the image data in a form of a file.

The displaying device 110 includes a display or a monitor displaying the image data.

Next, an operation of the imaging device, in the first embodiment, imaging the photographic subject and storing the obtained image data shall be described.

The light from the photographic subject enters the image sensor 101 via the lens unit 108. The image sensor 101 converts the entered light to the electric signal, and generates the analogue image signal by vertical driving and horizontal driving synchronizing with the driving pulse from the timing generator 102. Upon having the 1/f noise of the analogue image signal appropriately reduced by the CDS circuit in the CDS/AGC circuit 103, the AGC circuit provides automatic gain control to the analogue image signal. Then, the analogue-digital converter 104 converts the signal provided from the CDS/AGC circuit to the image signal data (RGB data); namely the digital signal.

The digital signal processing circuit 105 performs various kinds of processing on the provided digital signal via the memory circuit 106, the processing which includes the luminance signal processing, color separation processing, color matrix processing, the resizing, and data compressing processing. The generated image data is stored in the storing medium 109. The digital signal processing circuit 105 reads out the image data from the storing medium 109 in reproducing the recorded data. In the case where the read out image data is compressed data, the digital signal processing circuit 105 performs the expanding processing onto the compressed image data to resize the compressed image data in a display size, and forwards the resized image data to the displaying device 110.

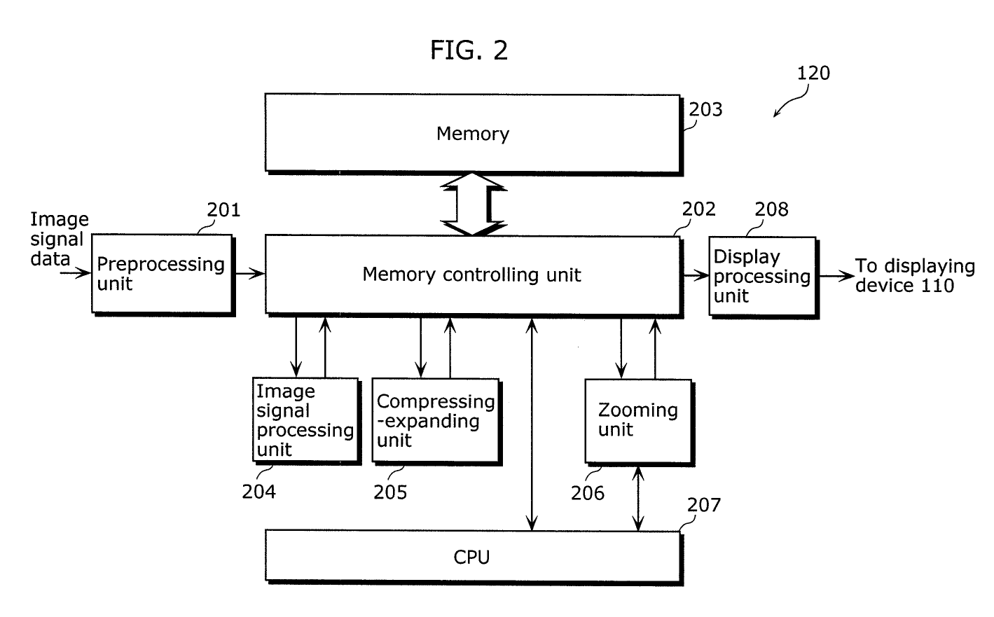

FIG. 2 is a block diagram illustrating a structure the image resizing unit 120 in the first embodiment. The image resizing unit 120 in FIG. 2 includes a preprocessing unit 201, a memory controlling unit 202, a memory 203, an image signal processing unit 204, a compressing-expanding unit 205, a zooming unit 206, a central processing unit (CPU) 207, and a displaying processing unit 208.

The preprocessing unit 201 performs processing (preprocessing), such as black-level correction and gain-correction, on the image signal data AD-converted by the analogue-digital converter 104. The image data with the preprocessing performed is written into the memory 203 via the memory controlling unit 202.

The memory controlling unit 202 controls writing and reading out of the data between the memory 203 and each of the units included in the image resizing unit 120.

The memory 203 stores the image data provided from the analogue-digital converter 104, and the image data having received each set of processing provided by the image resizing unit 120. The memory 203 corresponds to an entire or a part of the memory circuit 106.

The image signal processing unit 204: reads out the image data processed by the preprocessing unit 201 from the memory 203 via the memory controlling unit 202; and performs the luminance signal processing and the color signal processing on the read out image data. Luminance data obtained through the luminance signal processing and color difference data or RGB data obtained through the color signal processing is written in the memory 203 via the memory controlling unit 202.

The compressing-expanding unit 205 reads out the luminance data, and the color difference data or the RGB data from the memory 203 via the memory controlling unit 202, and performs: compressing on the read out luminance data, and the color difference data or the RGB data; and expanding meaning a reverse operation of the compressing processing. Each of the compressed data and expanded data is written into the memory 203 via the memory controlling unit 202.

The zooming unit 206 reads out the luminance data, and the color difference data or the RGB data from the memory 203 via the memory controlling unit 202, and performs the resizing on the read out luminance data, and the color difference data or the RGB data in two directions (horizontal and vertical directions, for example). Each of the data having received the resizing is written into the memory 203 via the memory controlling unit 202.

The zooming unit 206 performs resizing for display, as well. The resizing for display is processing to resize the image data obtained by the image sensor 101 in a displayable size on the displaying device 110 since most of such image data is larger in size than the displayable size on the displaying device 110.

The CPU 207 performs system operation control on each of the processing units included in the image resizing unit 120, using a controlling program. The CPU 207 corresponds to an entire or a part of the microcomputer 107.

The displaying processing unit 208 executes processing for displaying dividing reference lines on the image data having received the resizing for display, the dividing reference lines each of which represents a reference for dividing the image data in two directions. The image data processed by the displaying processing unit 208 is forwarded to the displaying device 110 to be displayed.

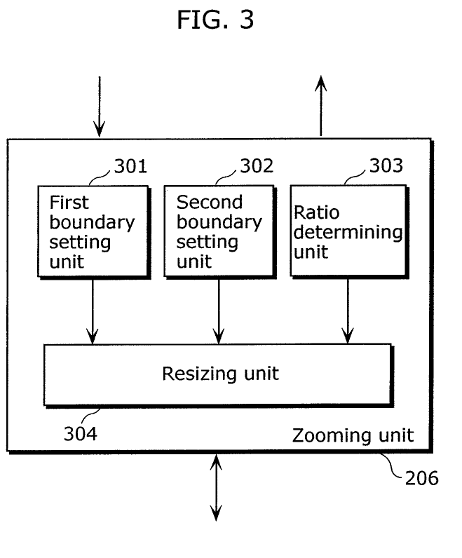

FIG. 3 is a block diagram illustrating a structure of the zooming unit 206 in the first embodiment. The zooming unit 206 in FIG. 3 includes a first boundary setting unit 301, a second boundary setting unit 302, a ratio determining unit 303, and a resizing unit 304.

The first boundary setting unit 301 sets n−1 boundaries (dividing reference lines) perpendicular to a first direction, the n−1 boundaries each of which divides an input image into n pieces (n is an integer of 2 or more) in the first direction. For example, the first boundary setting unit 301 sets n−1 dividing reference lines perpendicular to a vertical direction. Here, the dividing reference lines divide the input image into n pieces in the vertical direction.

The second boundary setting unit 302 sets m−1 boundaries (dividing reference lines) perpendicular to a second direction, the m−1 boundaries each of which divides the input image into m pieces (m is an integer of 2 or more) in the second direction. For example, the second boundary setting unit 302 sets m−1 dividing reference lines perpendicular to the horizontal direction. Here, the dividing reference lines divide the input image into m pieces in the horizontal direction.

It is noted that n=m may be represented. Further the first direction and the second direction are different and preferably perpendicular each other. In addition, since a typical image captured by a digital camera is a rectangle, the vertical and horizontal directions are preferably parallel to outer edges of the image (sides of the rectangle).

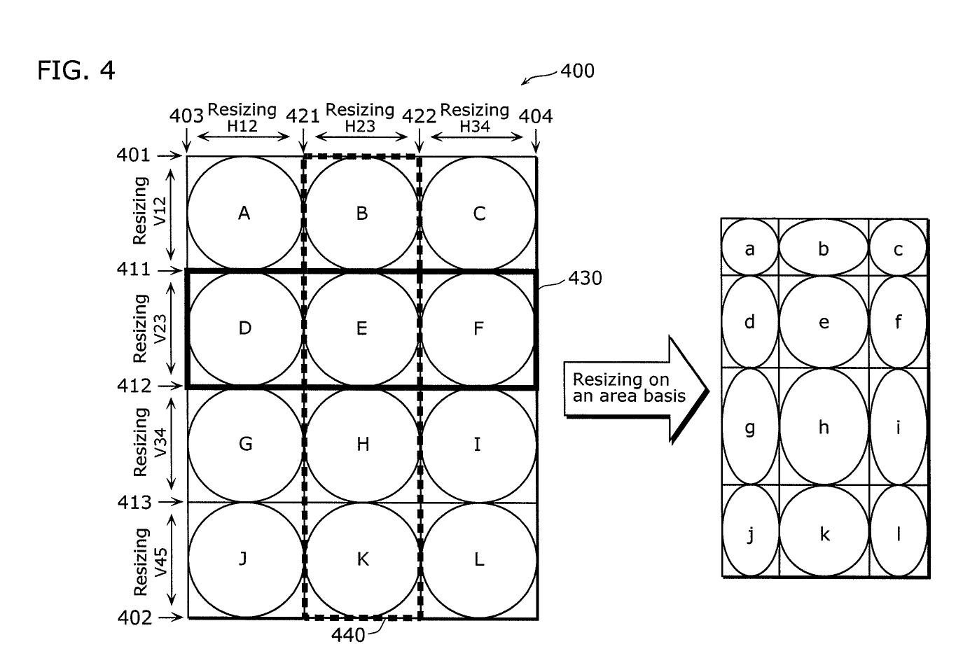

FIG. 4 exemplifies each of the dividing reference lines and divided areas. An input image 400 in FIG. 4 consists of a side 401, a side 402, a side 403, and a side 404. For example, the first boundary setting unit 301 sets three of the dividing reference lines 411, 412, and 413 perpendicular to the vertical direction. The second boundary setting unit 302 sets two of the dividing reference lines 421 and 422 perpendicular to the horizontal direction.

The ratio determining unit 303 determines a ratio for resizing performed by the resizing unit 304. In other words, the ratio determining unit 303 determines a first resizing ratio in the first direction and a second resizing ratio in the second direction, each of the first and the second resizing ratios being for an area subject to resizing. For example, a first resizing ratio is expressed as a ratio of: a length of a side, in the first direction, of a first divided area in an original image; and a length of a corresponding side after resizing. A second resizing ratio is expressed as a ratio of: a length of a side, in the second direction, of a second divided area in the original image; and a length of a corresponding side after resizing.

The above means that each of resizing ratios smaller than 1 represents a small area after resizing. Each of resizing ratios greater than 1 represents a larger area after resizing. It is noted that each of resizing ratio may not be a ratio of the sides.

The resizing unit 304 resizes the first divided area with the first resizing ratio determined by the ratio determining unit 303 in the first direction (the vertical direction), the first divided area which is defined by one or two boundaries set by the first boundary setting unit 301 and the outer edges of the input image. Further, the resizing unit 304 resizes the second divided area with the second resizing ratio determined by the ratio determining unit 303 in the second direction (the horizontal direction), the second divided area which is surrounded by one or two boundaries set by the second boundary setting unit 302 and the outer edges of the input image.

In the embodiment, specifically, the resizing unit 304 divides the image in the vertical or the horizontal direction. The following describes the image to be divided in the vertical direction. In other words, the image is to be divided with the dividing reference line perpendicular to the vertical direction. For example, FIG. 4 exemplifies the three dividing reference lines 411, 412, and 413 perpendicular to the vertical direction dividing the input image 400 in four. The following describes resizing on a divided area 430 which is one of strip images obtained through the dividing. It is noted that the divided area 430 is defined by the dividing reference lines 411 and 412 perpendicular to the vertical direction, and the sides 403 and 404 of the input image.

The ratio determining unit 303 determines a resizing ratio of the divided area 430 in a dividing direction (the vertical direction). The resizing unit 304 resizes the divided area 430, using the determined resizing ratio. Further, the ratio determining unit 303 determines resizing ratios on each area divided into three (D, E, and F) by two of the dividing reference lines 421 and 422 perpendicular to the horizontal direction in a non-dividing direction (the horizontal direction). The resizing unit 304 resizes the divided area 430, using the determined resizing ratios.

Further, the resizing unit 304 repeats similar processing to the other rectangular areas; namely, the divided areas. Here, the resizing ratio in the dividing direction (the vertical direction) can be freely determined; meanwhile, the resizing ratios determined in the first processing are used as the resizing ratios in the horizontal direction. This is because utilizing different resizing ratios for the horizontal direction produces boundaries of the strip images appearing on a re-synthesized image. In other words, the re-synthesized image appears to be badly deteriorated in image quality.

Next, operations of the image resizing unit in the first embodiment shall be described with reference to the drawings.

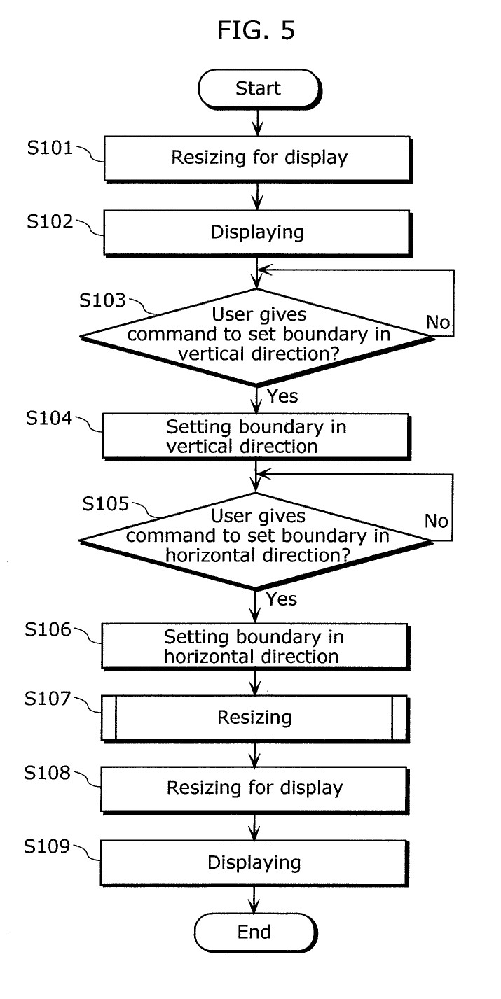

FIG. 5 is a flowchart illustrating operations of the image resizing unit 120 in the first embodiment.

The zooming unit 206 resizes an original image into a displayable size on the displaying device 110 (S101). Here, the original image has been processed by the preprocessing unit 201 and the image signal processing unit 204, and then stored in the memory 203. In other words, the zooming unit 206 performs the resizing for display.

The displaying device 110 displays the image with the resizing for display performed on by the zooming unit 206 (S102). Here, the displaying processing unit 208 displays auxiliary lines for setting each of dividing reference lines. Each of the auxiliary lines can be moved by a user command. The user moves the auxiliary line to a given position to determine a position of the dividing reference line via a user interface (not shown) included in the imaging device 100. The following exemplifies setting of the dividing reference line perpendicular to the horizontal direction, following setting of the dividing reference line perpendicular to the vertical direction.

When the user gives a command to set a boundary in the vertical direction (S103:Yes), the first boundary setting unit 301 sets each of the dividing reference lines perpendicular to the vertical direction in accordance with the command (S104). Specifically, the first boundary setting unit 301 causes the CPU 207 to estimate the position determined by the user moving the auxiliary lines on the displaying device 110, and determines the position of the dividing reference lines perpendicular to the vertical direction on the original image.

Next, when the user gives a command to set a boundary in the horizontal direction (S105:Yes), the second boundary setting unit 302 sets each of the dividing reference lines perpendicular to the horizontal direction in accordance with the command (S106). Specifically, the first boundary setting unit 302 causes the CPU 207 to estimate the position determined by the user moving the auxiliary lines on the displaying device 110, and determines the position of the dividing reference lines perpendicular to the horizontal direction on the original image.

The resizing unit 304 performs resizing on the divided area defined by the set dividing reference lines perpendicular to the vertical direction and the dividing reference lines perpendicular to the horizontal direction (S107). The details of this resizing shall be described hereinafter.

The zooming unit 206 again resizes the original image with the resizing (S107) performed in a displayable size on the displaying device 110 (S108). The displaying device 110 displays the image with the resizing for display performed on by the zooming unit 206 (S109).

The above process makes possible obtaining an image having the resizing performed on with partially varying ratios.

It is noted that the user can try the resizing again in the case where the image is not satisfactory enough for the user when the displaying device 110 displays the image at the end. In other words, the resizing process may be repeated at the setting of each of dividing reference lines (S103).

Moreover, any of the setting of the boundaries in the vertical direction (S103 and S104) and the setting of the boundaries in the horizontal direction (S105 and S106) can be performed first.

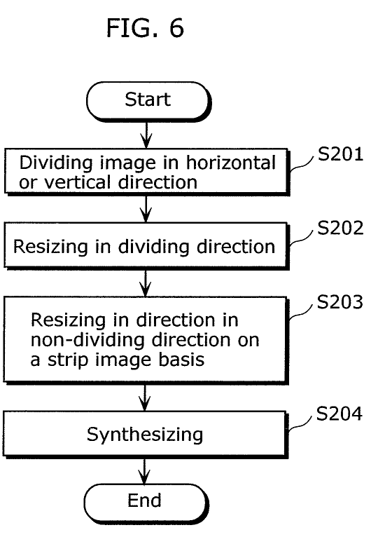

FIG. 6 is a flowchart illustrating details of the image resizing in the first embodiment.

First, the resizing unit 304 divides the original image in the vertical direction or the horizontal direction (S201). The following assumes the original image to be divided in the vertical direction. Specifically, the resizing unit 304 divides the original image, using a dividing reference line perpendicular to the vertical direction on the original. The resizing unit 304 stores strip images, to be obtained via the division, in the memory 203 as files. For example, FIG. 4 exemplifies the divided area 430 as a strip image. The strip image may be in a rectangular, a square, and a parallelogram (in the case where the dividing reference lines in two directions are not perpendicular each other.)

The resizing unit 304 executes the resizing, with ratios varied, in a dividing direction (the vertical direction) on a divided strip image basis (S202). In a non-dividing direction (the horizontal direction), the resizing unit 304 executes the resizing (S203), while varying the resizing ratios, designating points (the dividing reference lines perpendicular to the horizontal direction) as boundaries, instead of limiting the resizing ratio to the same ratio. Here, the phase before the resizing, in the direction in which the strip images are not to be arranged (the horizontal direction), dividing reference lines perpendicular to the horizontal direction should be set at the same positions of each of the strip images.

At the end of the resizing, the strip images, each of which has received the resizing, are re-synthesized in a memory space of the memory 203 (S204). Here, a piece of image is to be generated so as to prevent the image from being out of alignment at the boundaries for the synthesizing. In other words, at the end of the synthesizing processing, each of the dividing reference lines perpendicular to the horizontal direction set on a strip image basis needs to be formed in a straight line.

Specifically, when synthesizing the strip images while performing the resizing with: ratios changing on a divided image basis in the dividing direction; and the resizing ratios changing at the points designated as the boundaries in the non-dividing direction as well, instead of limiting to a single direction, the zooming unit 206 reads out via the memory controlling unit 202 the divided images from the original image stored in the memory space of the memory 203, and performs variable resizing on the divided images. The zooming unit 206 writes in advance the boundaries of the divided images forming a straight line in an arrangement space of the re-synthesized image to generate an image data resized and synthesized via a read-out operation and a writing operation from and to the memory by carrying out variable resizing for as many as the strip images.

As described above, dividing the original image into strip images and carrying out resizing on a strip image basis result in obtaining a resized image while partially changing the resizing ratios.

It is noted in the dividing processing (S201) that the dividing direction may be the horizontal direction.

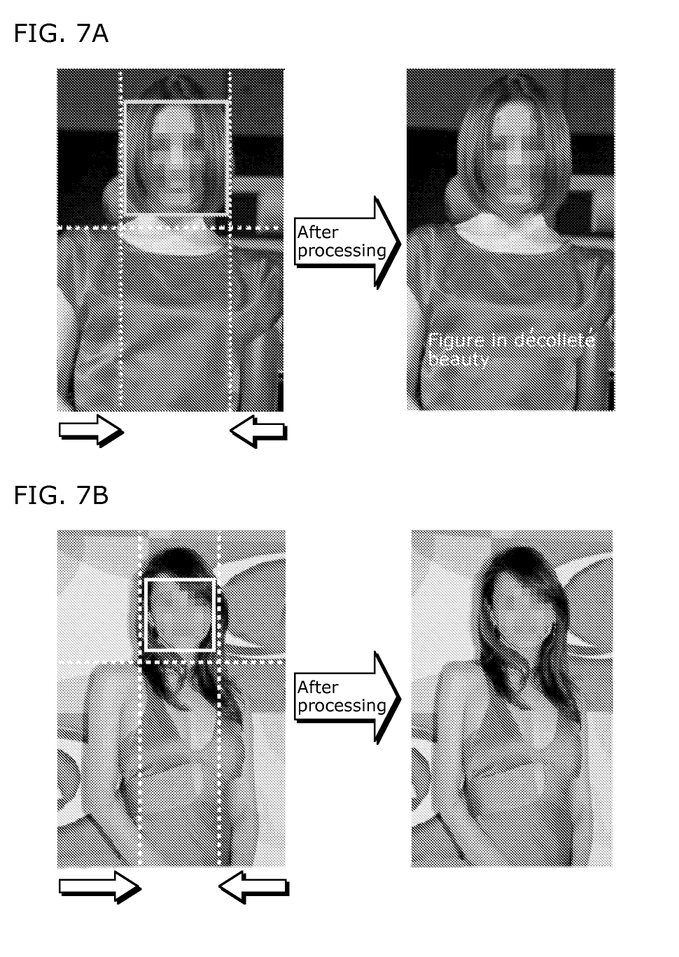

FIGS. 7A and 7B exemplify original images and after-resizing images displayed by the displaying device. As shown in FIG. 7A, the displaying device 110 displays the auxiliary lines and the original image. FIG. 7A exemplifies the auxiliary lines formed in dashed lines.

Via the user interface included in the imaging device, the user moves the auxiliary lines formed in dashed lines to a predetermined position and determine a position of the dividing reference lines. Resizing the original image in accordance with the determined dividing reference lines can produce a figure image in a décolleté beauty as shown in FIGS. 7A and 7B.

As described above, the image resizing device in the first embodiment can resize the image on a more finely-divided portion basis by setting reference lines for dividing the image in two directions; namely the first and the second directions. This can offer an image fully satisfying a user's natural desire.

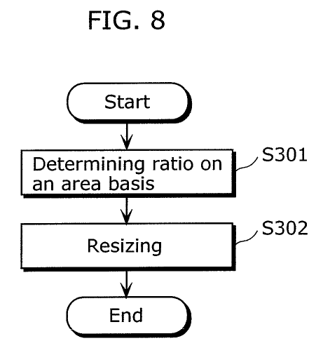

It is noted that the resizing (S107) shown in FIG. 5 is assumed to be processing in accordance with the flowchart in FIG. 6; instead, the resizing may be in accordance with the flowchart in FIG. 8.

FIG. 8 is a flowchart illustrating another resizing technique in the first embodiment.

Upon setting each of the dividing reference lines, the ratio determining unit 303 determines a resizing ratio (S301) on a basis of a divided area defined by the dividing reference lines and the outer edges of the original image.

The resizing unit 304 resizes each of the divided areas, using determined resizing ratios (S302). Specifically, the resizing unit 304 reads out the original image from the memory 203 via the memory controlling unit 202, and continuously executes the resizing with use of the determined resizing ratios, on a divided area basis, with each of the set dividing reference lines designating as a boarder.

The example shown in FIG. 4 illustrates resizing of the divided area 430 by the resizing unit 304, using the determined resizing ratios along with the vertical direction. Further, the divided area 440 is resized with use of the determined resizing ratio along with the horizontal direction. The resizing unit 304 executes the resizing, using the resizing ratios each determined for the corresponding divided area. As described above, the resizing unit 304 writes the resized image into the memory 203 via the memory controlling unit 202, by continuously executing the resizing while varying the divided areas.

It is noted that the ratio determining unit 303 determines the resizing ratios in the vertical direction with respect to the divided area defined by the dividing reference lines perpendicular to the vertical direction and the sides of the image (the divided area 430, for example). The ratio determining unit 303 determines the resizing ratio in the horizontal direction with respect to the divided area defined by the dividing reference lines perpendicular to the horizontal direction and the sides of the image (the divided area 440, for example).

The above can provide an image fully satisfactory to the user with simple processing.

When correcting the photographic subject's eyes, for example, the first boundary setting unit 301 and the second boundary setting unit 302 set the dividing reference lines in order for the dividing reference lines to surround the eyes to be corrected. Here, the dividing reference lines preferably set in order for the divided area defined by the dividing reference lines not to include parts other than the eyes as possible.

Then, when making the eyes look sparkling or large, the resizing unit 304 resizes the divided area including the eyes with a resizing ratio greater than resizing ratios of the divided areas surrounding the divided area including the eyes. To the contrary, when having the eyes looked narrow or small, the resizing unit 304 resizes the divided area including the eyes with a resizing ratio smaller than resizing ratios of the divided areas surrounding the divided area including the eyes.

Similar processing is employed when correcting another face part. The first boundary setting unit 301 and the second boundary setting unit 302 set the dividing reference lines in order to include a face part to be corrected. Here, the dividing reference lines preferably set in order for the divided area defined by the dividing reference lines not to include parts other than the eyes as possible.

When enlarging the face part, the resizing unit 304 resizes the divided area including the face part with a resizing ratio greater than resizing ratios of the divided areas surrounding the divided area including the face part. To the contrary, when reducing the face part, the resizing unit 304 resizes the divided area including the face part with a resizing ratio smaller than resizing ratios of the divided areas surrounding the divided area including the face part.

Similar processing is employed when correcting the whole body. The first boundary setting unit 301 and the second boundary setting unit 302 set the dividing reference lines in order to include a body part to be corrected. Here, the dividing reference lines preferably set so that the divided area defined by the dividing reference lines not to include body parts other than the body part to be corrected as possible.

Then, when making a body part appear slimmer, the resizing unit 304 resizes the divided area including the body part by using a smaller resizing ratio for the sliming direction (the vertical direction) of the divided area than for another direction (the horizontal direction). Specifically, the first boundary setting unit 301 and the second boundary setting unit 302 set the dividing reference lines in order to include an arm to be corrected. Then, the resizing unit 304 resizes the divided area in a crosswise direction, using a ratio smaller than a resizing ratio in a longitudinal direction along the arm (a direction from the shoulder to the wrist).

As described above, the image resizing device in the first embodiment can generate and offer a fully satisfactory image to the user with very simple processing.

### Second Embodiment

An image resizing device in a second embodiment detects a person's face to determine reference lines for division, in particular, in the case where the image is a portrait. The image resizing device in the second embodiment is included in an imaging device, similar to the first embodiment.

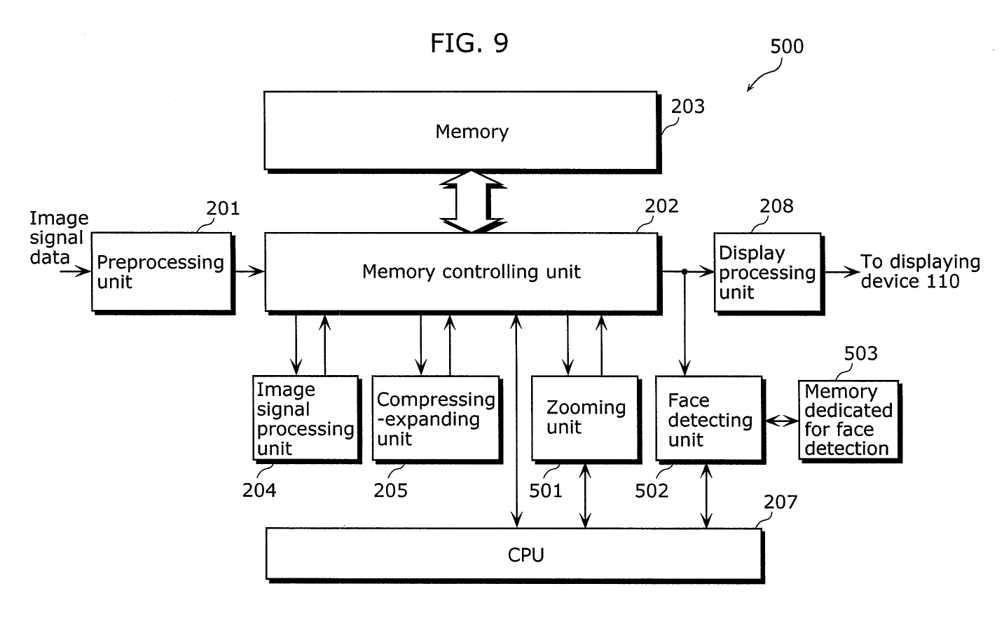

FIG. 9 is a block diagram illustrating a structure of the image resizing unit 500 in the second embodiment. Compared with the image resizing unit 120 in FIG. 2, the image resizing unit 500 in FIG. 9 includes a zooming unit 501 instead of the zooming unit 206, and additionally has a face detecting unit 502 and a memory dedicated for face detection 503. The following omits points similar to those in the first embodiment, and mainly describes differences with the first embodiment.

The zooming unit 501 reads out luminance data, color difference data, and RGB data from the memory 203 via the memory controlling unit 202, and performs image resizing in two directions on the read out luminance data, color difference data, and color difference data. Each of the data receiving the resizing is written in the memory 203 via the memory controlling unit 202.

The face detecting unit 502 detects the photographic subject's face out of an original image or an image having received resizing for display. Both of the original image and the image are stored in the memory dedicated for face detection 503. Specifically, the face detecting unit 502 obtains the center position of the face and the face size through arithmetic processing on the CPU 207. In addition, the face detecting unit 502 obtains thorough arithmetic processing on the CPU 207: a position of a face part which can be estimated out of the center position of the face and the face size, such as the eyes, the nose, and the mouth; and a position of a characteristic body part including the shoulders, the neckline, and the chest.

The memory dedicated for face detection 503 obtains, for example, an image having received the resizing for display from the displaying processing unit 208, and stores the image. Otherwise, the memory dedicated for face detection 503 obtains the original image from the memory 203 via the memory controlling unit 202, and stores the original image.

It is noted that the image resizing unit 500 may dispense with the memory dedicated for face detection 503. With the help of the memory dedicated for face detection 503, the image resizing unit 500 can reduce the data traffic of the memory controlling unit 202. This is because the face detecting unit 502 will result in reading out the original image from the memory 203 via the memory controlling unit 202 to detect the face in the case where the image resizing unit 500 does not include the memory dedicated for face detection 503.

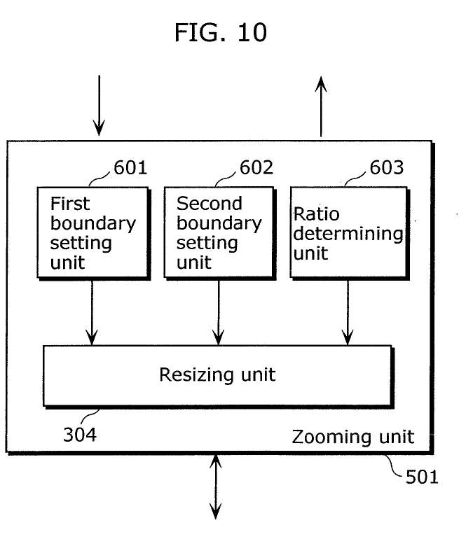

FIG. 10 is a block diagram illustrating a structure of the zooming unit 501 in the second embodiment. The zooming unit 501 in FIG. 10 includes a first boundary setting unit 601, a second boundary setting unit 602, a ratio determining unit 603, and a resizing unit 304. The resizing unit 304 in FIG. 10 performs the same processing as the resizing unit 304 in FIG. 3 does, and thus the description shall be omitted hereinafter.

Similar to the first boundary setting unit 301, the first boundary setting unit 601 sets n−1 boundaries, perpendicular to a first direction, for dividing an input image into n pieces. For example, the first boundary setting unit 601 sets n−1 dividing reference lines perpendicular to a vertical direction. Here, the dividing reference lines divide the input image into n pieces in the vertical direction. Here, the first boundary setting unit 601 sets the dividing reference lines perpendicular to the vertical direction based on the position of the face part or the characteristic body part detected by the face detecting unit 502.

Similar to the second boundary setting unit 302, the second boundary setting unit 602 sets m−1 dividing reference lines, perpendicular to a second direction, for dividing the input image into m pieces in the second direction. For example, the second boundary setting unit 602 sets m−1 dividing reference lines perpendicular to a horizontal direction for dividing the input image into m pieces in the horizontal direction. Here, the second boundary setting unit 602 sets each of the dividing reference lines perpendicular to the horizontal direction based on the position of the face part or the characteristic body part detected by the face detecting unit 502.

For example, the first boundary setting unit 601 and the second boundary setting unit 602 set the dividing reference lines perpendicular to the vertical direction and the dividing reference lines perpendicular to the horizontal direction, respectively, so that the dividing reference lines perpendicular to the vertical direction and the dividing reference lines perpendicular to the horizontal direction surround the position of the face part or the characteristic body part detected by the face detecting unit 502. Otherwise, the first boundary setting unit 601 and the second boundary setting unit 602 set the dividing reference lines perpendicular to the vertical direction and the dividing reference lines perpendicular to the horizontal direction, respectively, so that the dividing reference lines perpendicular to the vertical direction and the dividing reference lines perpendicular to the horizontal direction touch the position of the face part or the characteristic body part detected by the face detecting unit 502.

Specifically, when the face detecting unit 502 estimates the position of the eyes, the first boundary setting unit 601 and the first boundary setting unit 602 sets the dividing reference lines perpendicular to the vertical direction and the dividing reference lines perpendicular to the horizontal direction, respectively, so that the dividing reference lines perpendicular to the vertical direction and the dividing reference lines perpendicular to the horizontal direction surround the estimated eyes. Further, when the face detecting unit 502 estimates the position of the waist, the first boundary setting unit 601 and the second boundary setting unit 602 set the dividing reference lines perpendicular to the vertical direction and the dividing reference lines perpendicular to the horizontal direction, so that the dividing reference lines perpendicular to the vertical direction and the dividing reference lines perpendicular to the horizontal direction touch the estimated waist.

The ratio determining unit 603 determines ratios of the resizing by the resizing unit 304 based on the position of the face part or the characteristic body part detected by the face detecting unit 502.

When, for example, the face detecting unit 502 estimates the position of the eyes, and the first boundary setting unit 601 and the second boundary setting unit 602 set the dividing reference lines perpendicular to a vertical direction and the dividing reference lines perpendicular to a horizontal direction to surround the estimated eyes, the ratio determining unit 603 determines the resizing ratios in the vertical and horizontal directions in order to, for example, enlarge the eyes. For example, the ratio determining unit 603 determines a resizing ratio having a value greater than 1, so that the eyes will be large in the resized image both in the vertical and horizontal directions.

The above structure allows the imaging device in the second embodiment to automatically resize a captured image through internal processing (eliminating the need for user setting). This can easily provide an image fully satisfactory to the user.

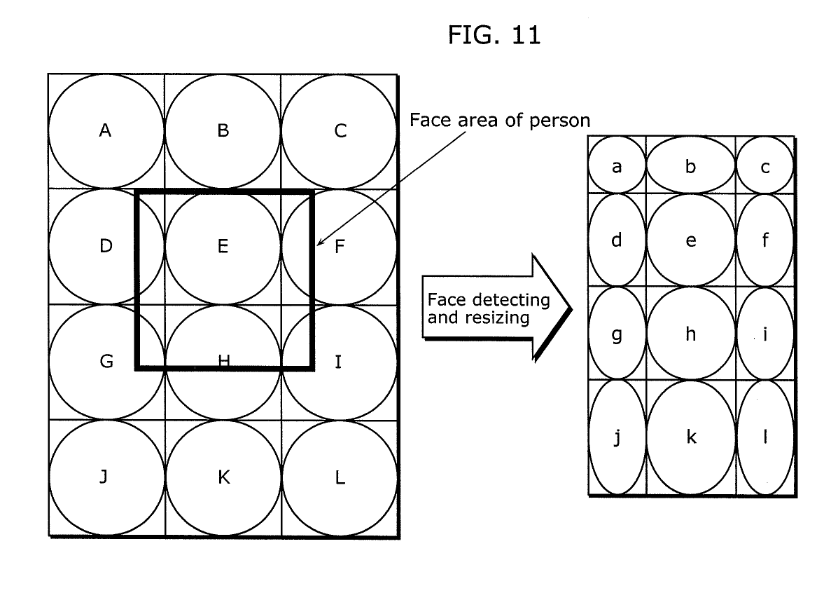

FIG. 11 exemplifies each of the dividing reference lines and a divided area.

As shown in FIG. 11, each of the dividing reference lines is set lo based on the position of the face detected by the face detecting unit 502, and the divided area, defined by the set one or two of the dividing reference lines and outer edges of the image, is resized. Here, an automatic change of the resizing ratio, based on the position of the face part and the position of the characteristic body part estimated out of detected face, enables a user-desired image to be produced. The automatic change of the resizing ratio is provided on a divided area basis.

FIG. 7B exemplifies the original image and after-resizing image shown by the displaying device. As shown in FIG. 7B, the image resizing unit in the second embodiment generates an image of the photographic subject in a décolleté-beauty look.

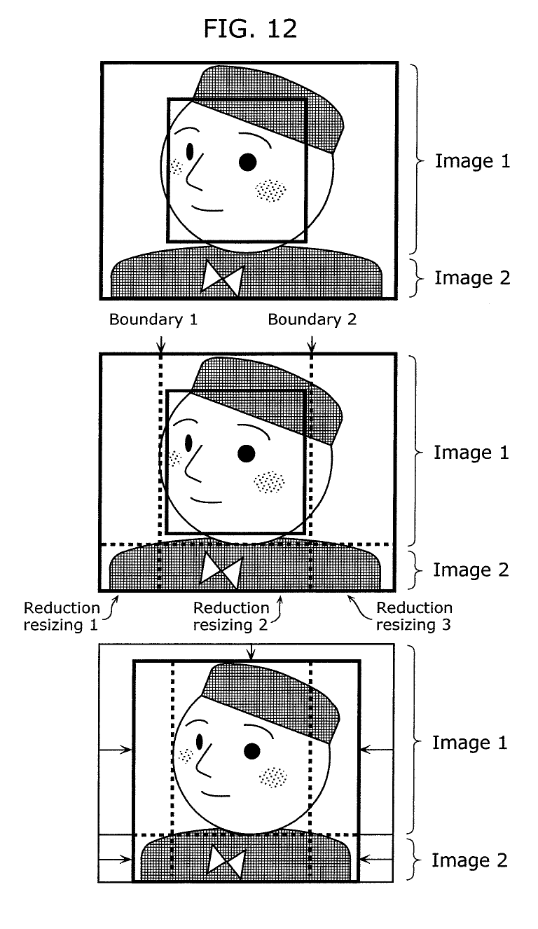

FIG. 12 shows setting of each of the dividing reference lines by face detecting and resizing.

In the example shown in FIG. 12, each of the dividing reference lines is set in order to define a face area indicating the position of the detected face. The original image is divided into two strip images (images 1 and 2) by the dividing reference line perpendicular to the vertical direction, and each of the strip images is resized in a respective resizing ratio. Further, in the horizontal direction, the face area is resized with a different resizing ratio based on each of the areas divided by the dividing reference lines perpendicular to the horizontal direction. In the example shown in FIG. 12, synthesizing the resized strip images can generate an image of a narrow-shouldered person.

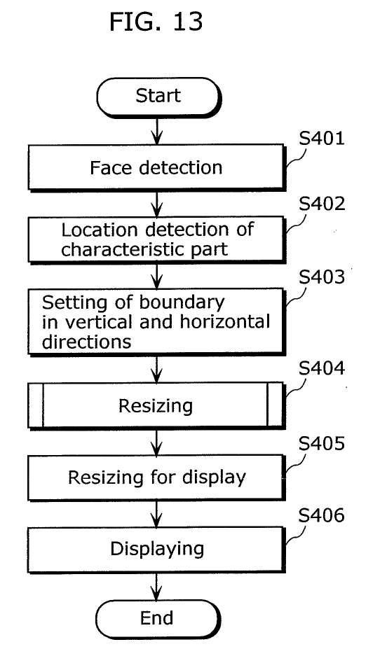

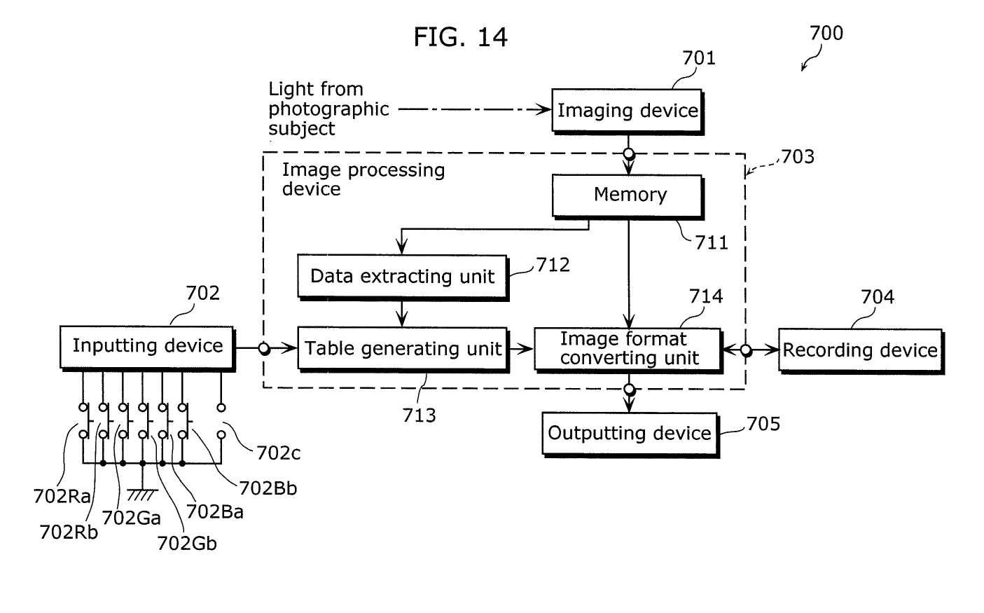

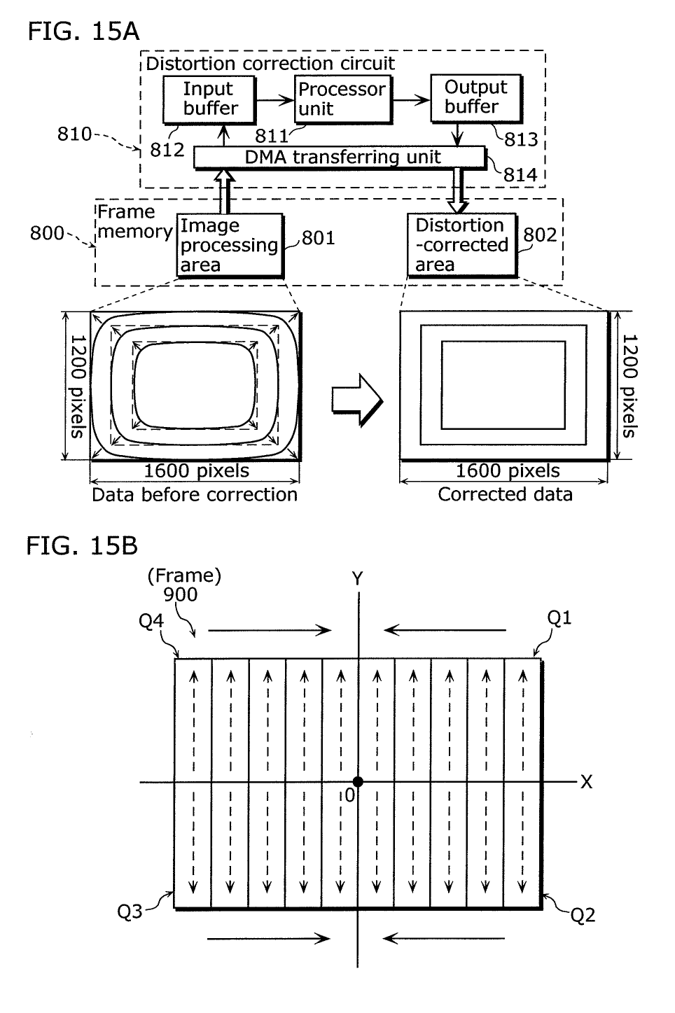

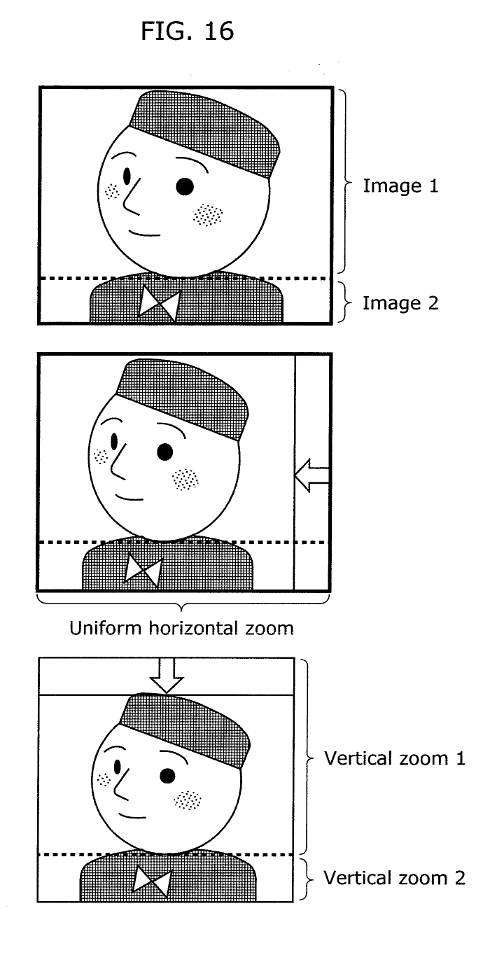

FIG. 13 is a flowchart illustrating operations of the image resizing unit 500 in the second embodiment.

The face detecting unit 502 detects the face out of the image stored in the memory dedicated for face detection 503 (S401). Further, the face detecting unit 502 estimates, through arithmetic processing on the CPU 207, at least one of the positions of the face parts, and the positions of the characteristic body parts according to information on the detected face.

The first boundary setting unit 601 and the second boundary setting unit 602 set the dividing reference lines perpendicular to the vertical direction and the dividing reference lines perpendicular to the horizontal direction in order to define the estimated positions of the face part and the characteristic body part.

The resizing unit 304 executes the resizing on the divided area defined by the set dividing reference lines perpendicular to the vertical direction and dividing reference lines perpendicular to the horizontal direction. The resizing is shown in FIG. 6 or FIG. 8.

The zooming unit 501 resizes the original image having received the resizing (S404) in a displayable size on the displaying device 110 (S405). The displaying device 110 displays the image having received the resizing for display on the zooming unit 501 (S406).

The above makes possible obtaining an image receiving the resizing having partially varying ratios.

It is noted that the resizing may be executed again in the case where the user judges the image not to be satisfactory enough when the displaying device 110 displays the image in the end. Specifically, the displaying processing unit 208 displays movable auxiliary lines on the displaying device 110, so that the displaying processing unit 208 can receive a command from the user, as the displaying processing unit 208 has done in the first embodiment.

As described above, the image resizing device in the second embodiment detects the face and estimates the position of the face part and the position of the characteristic body part, so that the image resizing device can set the dividing reference lines, eliminating the need for the user setting the dividing reference lines.

This can easily provide an image fully satisfactory to the user, dispensing with complex operations the user has to handle.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

In the second embodiment, for example, the face detecting unit 502 estimates the position of the face part and the position of the characteristic body part out of the center position of the face and the face size. Meanwhile, the face detecting unit 502 may use information on the face tilted in vertical and horizontal directions, or rotating information with respect to the reference axis to perform calculation for improving an estimated position. Specifically, the face detecting unit 502 detects a direction and an angle for and at which the face tilts out of the vertical and the horizontal directions of the face, and estimates the position of the face part based on the detected direction and angle. In addition, obtaining an angle (rotation information) between the axis of the body and the reference axis (the vertical direction of the image, for example) allows the face detecting unit 502 to estimate the position of the characteristic body part. The use of the information on the tilting face or the tilting body makes possible improving accuracy of the position of the dividing reference lines to be set, and the resizing ratios.

Moreover, in the second embodiment the use of the face detecting automatically determines the position of the dividing reference lines and the resizing ratios. Meanwhile, the auxiliary lines for determining position of the dividing reference lines and resizing ratio as a result of the face detection may be temporarily displayed on the displayed image through displaying processing. Then, upon confirmation of the user, the resizing may be performed, following correction of the position, if necessary. This makes possible enhancing the accuracy of the position of the dividing reference lines to be set and the resizing ratios.

As described in the above, the present invention may be implemented as a program to cause a computer to execute an image resizing method in each of the embodiments, as well as the image resizing device and the image resizing method. The present invention may also be implemented as a storing medium to store the program, such as a computer-readable CD-ROM. Moreover, the present invention may be implemented as information, data, and a signal indicating the program. The program, information, data, and signal may be distributed via a communication network including the Internet.

Further, in the present invention, a part or all of the structural elements included in the image resizing device may be formed out of a system Large Scale Integration (LSI). The system LSI, an ultra-multifunction LSI, is manufactured with plural structural units integrated on a single chip. Specifically, the system LSI is a computer system having a micro processor, a ROM, and a RAM.

### INDUSTRIAL APPLICABILITY

An image resizing device in the present invention is applicable to, for example, a digital still camera and a displaying appliance. The image resizing can satisfy the user's natural desire to look “slender, beautiful, a décolleté beauty, to have sparkling eyes, to have a slender face, and to have firm upper arms.

What is claimed is:

1. An image resizing device which resizes at least a part of an input image, said image resizing device comprising:
a first boundary setting unit configured to set n−1 first boundaries perpendicular to a first direction, the n−1 first boundaries dividing the input image into n in the first direction where n is an integer not less than 2;
a second boundary setting unit configured to set m−1 second boundaries perpendicular to a second direction, the m−1 second boundaries dividing the input image into m in the second direction which is different from the first direction where m is an integer not less than 2; and
a resizing unit configured to resize a first divided area with a first ratio in the first direction, and to resize a second divided area with a second ratio, that is different from the first ratio, in the second direction, the first divided area being defined by one or two of the first boundaries and an outer edge of the input image, and the second divided area being defined by one or two of the second boundaries and an outer edge of the input image.

2. The image resizing device according to claim 1, further comprising
a displaying unit configured to display an image for display corresponding to the input image,
wherein said displaying unit is further configured to display on the image for display an auxiliary line for determining positions of the first and second boundaries, the auxiliary line being movable, and
on a basis of the auxiliary line, said first boundary setting unit is configured to set the first boundary, and said second boundary setting unit is configured to set the second boundary.

3. The image resizing device according to claim 1, further comprising:
a face detecting unit configured to detect a face of a photographic subject in the input image; and
a position estimating unit configured to estimate positions of the face and a body part of the photographic subject, using information on the face detected by said face detecting unit,
wherein said first boundary setting unit is configured to set the first boundary, and said second boundary setting unit is configured to set the second boundary, based on the positions of the face and the body part of the photographic subject, the positions being estimated by said position estimating unit.

4. The image resizing device according to claim 3,
wherein said position estimating unit is configured to estimate a face part position indicating at least one of positions of an eye, a nose, and a mouth of the photographic subject, and said first boundary setting unit is configured to set the first boundary, and said second boundary setting unit is configured to set the second boundary, based on the face part position estimated by said position estimating unit.

5. The image resizing device according to claim 4,
wherein said first boundary setting unit is configured to set the first boundary and said second boundary setting unit is configured to set the second boundary, so that the first and second boundaries surround at least one of face part positions, including the face part position, estimated by said position estimating unit.

6. The image resizing device according to claim 3,
wherein said position estimating unit is configured to estimate a body part position indicating at least a position of a neck, a shoulder, and a waist of the photographic subject, and
said first boundary setting unit is configured to set the first boundary, and said second boundary setting unit is configured to set the second boundary, based on the body part position estimated by said position estimating unit.

7. The image resizing device according to claim 6,
said first boundary setting unit is configured to set the first boundary, and said second boundary setting unit is configured to set the second boundary, so that the first and second boundaries touch at least one of body part positions, including the body part position, estimated by said position estimating unit.

8. The image resizing device according to claim 3,
wherein said face detecting unit is configured to detect the face of the photographic subject in the input image to obtain face information of the face on the center position, a size, a vertical direction, a horizontal direction, and a rotation direction, and
said position estimating unit is configured to estimate the positions of the face and the body part of the photographic subject, using the face information obtained by said face detecting unit.

9. The image resizing device according to claim 1, further comprising:
a face detecting unit configured to detect a face of a photographic subject in the input image;
a position estimating unit configured to estimate positions of the face and a body part of the photographic subject, using information on the face detected by said face detecting unit; and
a displaying unit configured to display an image for display corresponding to the input image,
wherein said displaying unit is further configured to display on the image for display an auxiliary line for determining positions of the first and second boundaries based on the positions of the face and the body part of the photographic subject estimated by said position estimating unit, the auxiliary line being movable, and
on a basis of the auxiliary line, said first boundary setting unit is configured to set the first boundary, and said second boundary setting unit is configured to set the second boundary.

10. An image resizing method for resizing at least a part of an input image, said image resizing method comprising:
setting n−1 first boundaries perpendicular to a first direction, the n−1 first boundaries dividing the input image into n in the first direction where n is an integer not less than 2;
setting m−1 second boundaries perpendicular to a second direction, the m−1 second boundaries dividing the input image into m in the second direction which is different from the first direction where m is an integer not less than 2; and
resizing a first divided area with a first ratio in the first direction and a second divided area with a second ratio, that is different from the first ratio, in the second direction, the first divided area being defined by one or two of the first boundaries and an outer edge of the input image, and the second divided area being defined by one or two of the second boundaries and an outer edge of the input image.

11. A camera including an image resizing unit which resizes at least a part of an input image,
wherein the image resizing unit comprises:
a first boundary setting unit configured to set n−1 first boundaries perpendicular to a first direction, the n−1 first boundaries dividing the input image into n in the first direction where n is an integer not less than 2;
a second boundary setting unit configured to set m−1 second boundaries perpendicular to a second direction, the m−1 second boundaries dividing the input image into m in the second direction which is different from the first direction where m is an integer not less than 2; and
a resizing unit configured to resize a first divided area with a first ratio in the first direction, and to resize a second divided area with a second ratio, that is different from the first ratio, in the second direction, the first divided area being defined by one or two of the first boundaries and an outer edge of the input image, and the second divided area being defined by one or two of the second boundaries and an outer edge of the input image.

12. A computer program of an image resizing method for resizing at least a part of an input image, said computer program causing a computer to execute:
setting n−1 first boundaries perpendicular to a first direction, the n−1 first boundaries dividing the input image into n in the first direction where n is an integer not less than 2;
setting m−1 second boundaries perpendicular to a second direction, the m−1 second boundaries dividing the input image into m in the second direction which is different from the first direction where m is an integer not less than 2; and
resizing a first divided area with a first ratio in the first direction and a second divided area with a second ratio, that is different from the first ratio, in the second direction, the first divided area being defined by one or two of the first boundaries and an outer edge of the input image, and the second divided area being defined by one or two of the second boundaries and an outer edge of the input image.

13. An integrated circuit which resizes a part of an input image, said integrated circuit comprising:
a first boundary setting unit configured to set n−1 first boundaries perpendicular to a first direction, the n−1 first boundaries dividing the input image into n in the first direction where n is an integer not less than 2;
a second boundary setting unit configured to set m−1 second boundaries perpendicular to a second direction, the m−1 second boundaries dividing the input image into m in the second direction which is different from the first direction where m is an integer not less than 2; and
a resizing unit configured to resize a first divided area with a first ratio in the first direction, and to resize a second divided area with a second ratio, that is different from the first ratio, in the second direction, the first divided area being defined by one or two of the first boundaries and an outer edge of the input image, and the second divided area being defined by one or two of the second boundaries and an outer edge of the input image.
